(19) United States
(12) Patent Application Publication
(10) Pub. No.: US 2022/0323842 A1
(43) Pub. Date: Oct. 13, 2022

(54) HOCKEY PUCK

(71) Applicant: Airseg AS, Sandnes (NO)

(72) Inventors: Alexander IBRAGIMOV, Sola (NO); Romans Saricevs, Stavanger (NO); Erik Grindheim, Sandnes (NO)

(73) Assignee: Airseg AS, Sandnes (NO)

(21) Appl. No.: 17/761,938

(22) PCT Filed: Sep. 17, 2020
(86) PCT No.: PCT/EP2020/075938

§ 371 Date: Mar. 18, 2022

(30) Foreign Application Priority Data
Sep. 25, 2019 (NO) NO20191153

(51) Int. Cl. A63B 69/00; A63B 67/14; A63B 71/06; A63B 24/00

(52) U.S. Cl. CPC A63B 69/0026; A63B 67/14; A63B 71/0622; A63B 24/0021; A63B 2220/833; A63B 2220/40; A63B 2102/24

(57) ABSTRACT

A hockey puck (1) comprising an accelerometer (101) arranged in a recess (5) of a puck body (3). The accelerometer (101) is configured to measure the acceleration of the hockey puck (1) in at least one direction in x-y-z coordinates. The hockey puck further comprises a power supply (25) and a control unit (109) configured to read sensor input from the accelerometer (101) and to provide a control unit output based on said sensor input.

### TECHNICAL FIELD

The present invention relates to sport equipment, and more specifically to hockey pucks for practice and development of individual ice hockey skills like stick handling, passes and shots.

### BACKGROUND ART

In the field of ice hockey practice equipment, various types of hockey pucks both for practice on and off ice are used. Hockey pucks are usually made of rubber or plastic and have the shape of a disk. Rubber pucks are usually used on ice, while plastic pucks are used on other surfaces. Both are used for practicing passes and shots. Stick handling, passing and shooting are important skills in ice hockey.

The ability to receive a pass in such a way that the puck is “sitting on the stick blade” is vital. In order to develop such skill, soft stick-handling ability is important. Receiving a pass should happen very softly and the hockey stick should follow the puck movement to decrease the impact force, otherwise the puck is likely to bounce away after hitting the stick. A player needs exercise for soft puck receiving. Such exercise often takes place under supervision of a coach who can give feedback on the quality of the exercise.

Another exercise aspect is practicing puck shots.

Puck rotation speed is another important parameter, because the gyroscopic effect increases the puck's stability when the puck is in the air.

There are known various types of practicing pucks and other equipment for practicing passes and shots as well as some pucks containing electronic components.

For example, publication U.S. Pat. No. 5,564,698 discloses a hockey puck having an electromagnetic transmitter. The electromagnetic transmitter is turned on using a shock sensor and is turned off using a timer. The purpose is to enable enhancement of the puck on a television.

Moreover, publication EP1932569 relates to a hockey puck with a built-in light source that is visible through a translucent member. The light makes it easier to see the hockey puck, in particular in conditions with poor light.

Publications U.S. Pat. Nos. 4,968,036 and 4,846,475 also present a hockey puck having a light source.

Common hockey pucks merely constitute a cylindrical disc without any additional function. As shown above, solutions have been presented for hockey pucks that makes it easier to observe the hockey puck.

### SUMMARY OF INVENTION

According to the present invention, a hockey puck with an accelerometer is provided. The accelerometer is arranged in a recess of a puck body, and the accelerometer is configured to measure the acceleration of the hockey puck in at least one direction in x-y-z coordinates. The hockey puck further comprises a power supply and a control unit configured to read sensor input from the accelerometer and to provide a control unit output based on said sensor input.

Advantageously, the accelerometer can be configured to measure acceleration in more than one direction in x-y-z coordinates.

The hockey puck according to the invention will have a center of gravity. In some embodiments, the accelerometer can be placed away from the pucks center of gravity. When the puck is rotating while moving with constant or zero speed, the axis of rotation will pass through the center of gravity. If the accelerometer is placed away from the center of gravity, it is also away from the rotation axis. Therefore, the accelerometer will experience centripetal acceleration that is proportional to the rotation speed. That way the accelerometer will be able to sense the rotation speed. This concept only works if the accelerometer is placed away from the rotation axis. Otherwise, there will be no centripetal acceleration due to rotation speed. In some embodiments where the accelerometer is placed away from the puck's center of gravity, the control unit is configured to measure rotational speed by interpreting input as measured with the accelerometer.

In other embodiments, the accelerometer is located substantially at the center of gravity.

In some advantageous embodiments, the accelerometer can be a first accelerometer and that the hockey puck can further comprise a second accelerometer. The measuring range of the first accelerometer and the measuring range of the second accelerometer can then be different. By having two different accelerometers with different measuring ranges, one can obtain a more detailed measurement over a larger total measuring range.

In some embodiments, the hockey puck can further comprise a gyro. The gyro can be configured to measure rotational speed of the hockey puck.

In embodiments where the hockey puck comprises a gyro, which is configured to measure the rotation speed, one does not need to arrange the accelerometer away from the center of gravity in order to measure rotational speed. In such embodiments, the only purpose of the accelerometer can thus be to sense the impact forces. Then it does not matter whether the accelerometer is placed in the center of gravity or not.

In some embodiments, the power supply can be connected to a wireless charger.

Furthermore, in some embodiments the hockey puck according to the invention may further comprise an audible generator, which is configured to produce a sound based on the control unit output, as the audible generator is operated by the control unit. In addition, or instead, it may comprise a light source configured to provide a light, based on the control unit output, as the light source is operated by the control unit.

In some embodiments, the hockey puck may comprise a radio signal transceiver or transmitter antenna configured for data exchange with an external device. This enables the user to program the hockey puck for various exercises, such as soft receiving of the puck, or hard shots. Moreover, it may in some embodiments enable the user, such as a coach, to download and store recorded values after a training session. As the skilled person will appreciate, the control unit will have or will be connected to a memory unit. The memory unit may typically store measured values, such as measured accelerations stored during a training session. The memory unit may typically also store pre-defined training sessions or training modes.

In some embodiments though, it will be possible for the user to pre-define a training mode, such as with a tablet, and to load that training mode into the memory unit of the hockey puck.

Advantageously, the hockey puck may further comprise a lid made of a transparent material.

Moreover, the lid can advantageously comprise flexible wall sections with radially extending lips. The lips can be configured to engage with a notch provided in the recess.

In some embodiments, the said recess is a first recess recessed in a first body surface and the puck body can further comprise a second recess recessed in a second, opposite body surface. A channel may extend between the first and second recesses.

Advantageously, in embodiments including the wireless charger, the wireless charger can be arranged in the second recess and electrically connect with the power supply through the channel extending between the said recesses. Furthermore, a respective transparent lid can be arranged in both the first and second recesses, enabling light to be transmitted through the lids.

In other embodiments, in addition to or instead of the wireless charger, the hockey puck may comprise an energy harvester. Such an energy harvester can be configured to generate electric energy from the movements of the hockey puck. In such embodiments, one may obtain a hockey puck that is self-charging when used.

According to a second aspect of the present invention, there is provided a method of practicing ice hockey by using a hockey puck as the hockey puck discussed above. The method comprises

a) establishing a wireless communication path between the control unit and an external device, such as a smart phone, computer, or tablet;
b) with the external device, configuring a practice session mode in the control unit, including adjusting a setting of impact force, rotation speed, or other practice parameters;
c) handling the hockey puck with a hockey stick, such as by passing or shooting; wherein the method comprises one or more of the following steps:
d) during step c), storing measured practice parameters in a memory unit in the hockey puck; and/or
e) with the control unit, actuating output parameters, such as sound with the audible generator and/or light with the light source, as immediate feedback to the player practicing ice hockey.

### DETAILED DESCRIPTION OF THE INVENTION

While the present invention has been discussed in general terms above, some advantageous details of an embodiment will be presented in the following with reference to the drawings, in which

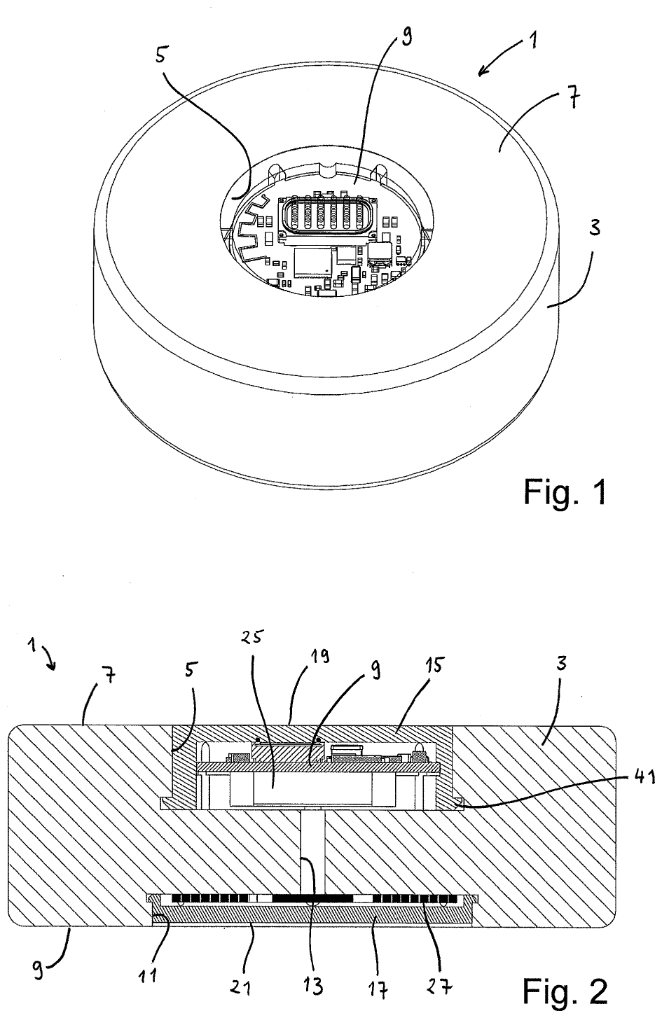

FIG. 1 is a perspective view of a hockey puck according to the invention;

FIG. 2 is a cross-section side view through the hockey puck shown in FIG. 1;

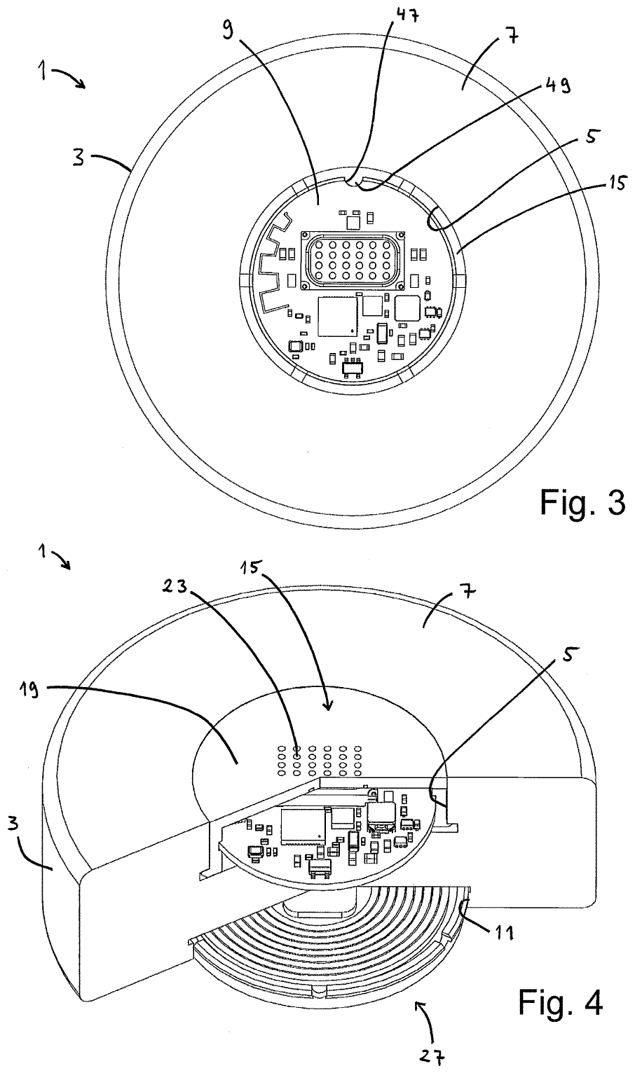

FIG. 3 is a top view of the hockey puck shown in FIG. 1;

FIG. 4 is a perspective cross-section view through the hockey puck;

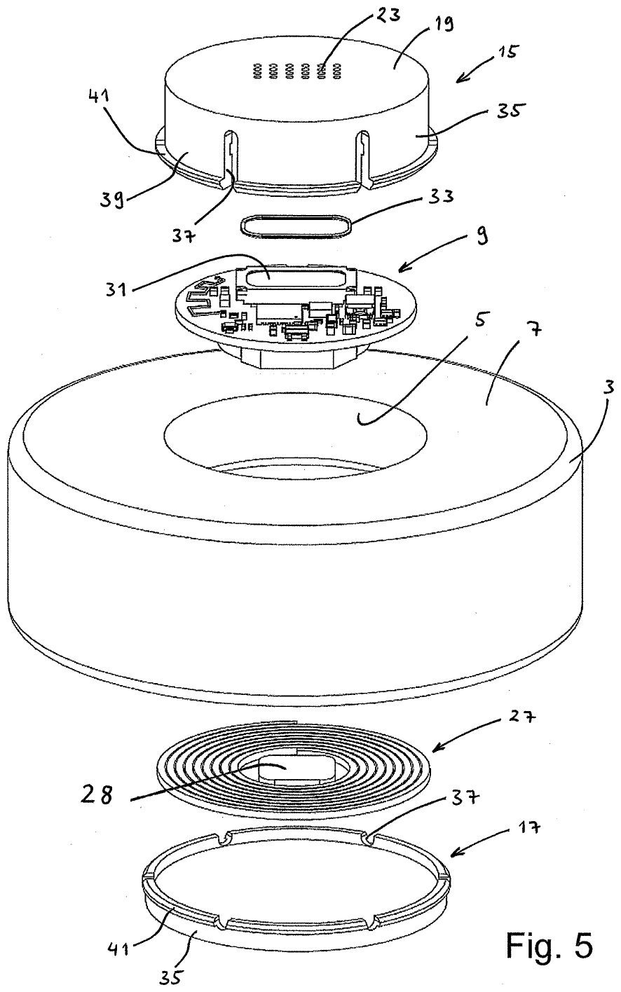

FIG. 5 is an exploded perspective view of the hockey puck;

FIG. 6 is an enlarged portion of the cross-section view shown in FIG. 2;

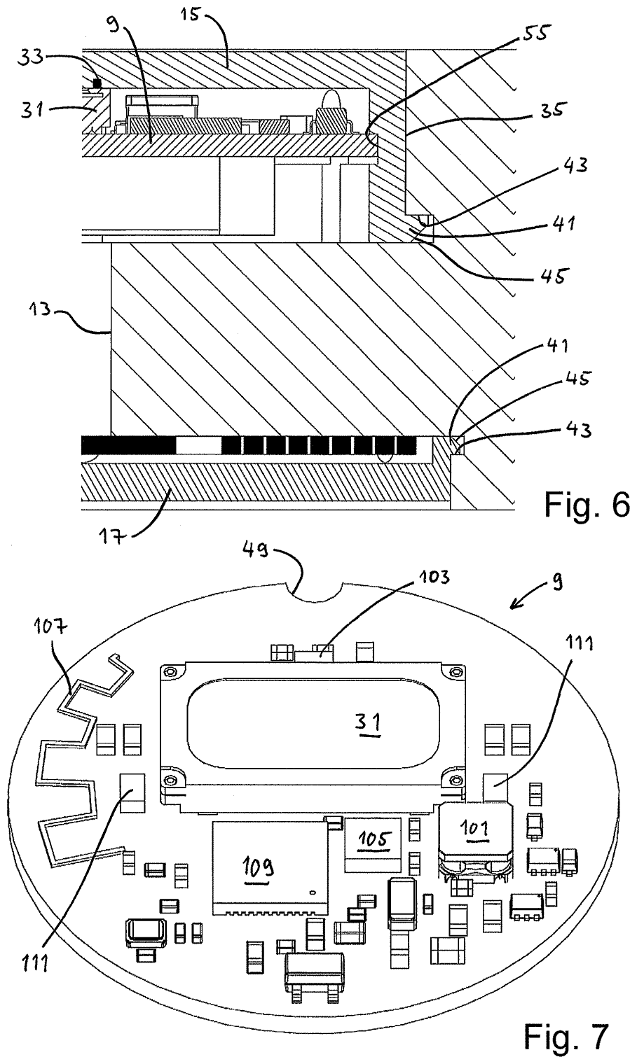

FIG. 7 is a perspective view of a circuit board arranged inside the hockey puck; and

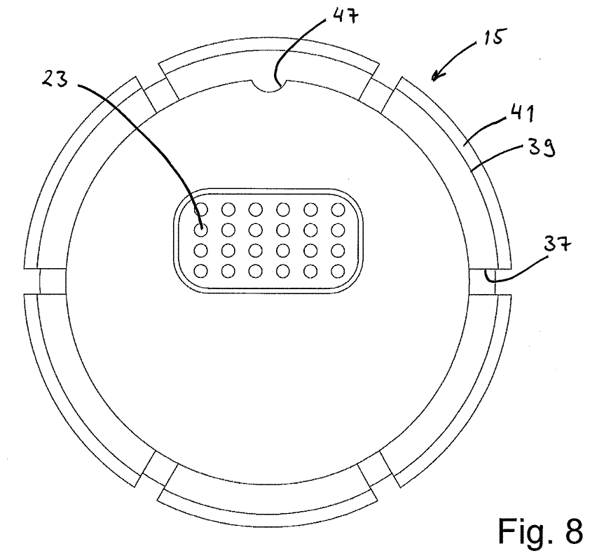

FIG. 8 is a top view of a lid configured to cover the circuit board.

FIG. 1 shows a hockey puck 1 according to the present invention. As any other common hockey puck, it is shaped as a circular disc. Typically it may be made of a rubber and/or plastic. It comprises a puck body 3. A first recess 5 is formed in the puck body 3. The first recess 5 is recessed with respect to a first body surface 7. The first body surface 7 is even and flat, as a common hockey puck.

Arranged inside the first recess 5 is an electric circuit board 9.

FIG. 2 shows the hockey puck 1 in FIG. 1 with a cross-section side view. Opposite of the first body surface 7 the hockey puck 1 has a second body surface 9. Recessed with respect to the second body surface 9, there is a second recess 11.

In this embodiment there is a channel 13 extending between the first and second recesses 5, 11. Advantageously, the channel 13 can be arranged centrally in the puck body 3 and extend in a direction that is perpendicular with respect to the first and second body surfaces 7, 9, which are parallel.

Also shown in FIG. 2 is a first lid 15 arranged in the first recess 5. A second lid 17 is arranged in the second recess 11. The first and second lids 15, 17 each have a respective flat lid surface 19, 21 that is substantially flush with the first and second body surfaces 7, 9, respectively, when mounted to the puck body 3. In some advantageous embodiments, the flat lid surfaces 19, 21 may be recessed with respect to the first and second body surfaces 7, 9. The first and second lids 15, 17 will be discussed in detail further below.

Between the electric circuit board 9 and the bottom of the first recess 5 there is a power supply 25. The power supply may typically be in form of a battery attached to the electric circuit board 9, such as a button cell battery.

FIG. 3 is a top view showing substantially the same components that are shown in FIG. 1.

Reference is now made to FIG. 4, where a portion of the puck body 3 is cut away for illustrational purpose. The first lid 15 is provided with at least one acoustic transmission arrangement, here in the form of a plurality of through holes 23. The through holes 23 are arranged in the lid surface 19 of the first lid 15. The acoustic transmission arrangement is provided for transmission of sound from an audible generator, which will be discussed further below.

In the embodiment illustrated herein, a wireless charger 27 is arranged in the second recess 11. The wireless charger 27 is configured to be charged wirelessly by placing the hockey puck 1 on a wireless charging device (not shown). Such a charging device could typically be a charging device configured for charging a smartphone, a tablet or the like. Although not shown, an electric connection would be provided between the wireless charger 27 and the power supply 25. Hence, in embodiments including the wireless charger 27, the power supply 25 would be a rechargeable battery.

The exploded perspective view of FIG. 5 shows various components of the hockey puck 1. Arranged together with the wireless charger 27 is an energy harvester 28. The energy harvester 28 is configured to convert kinetic energy into electric energy. The harvested energy is used for charging the power supply 25, typically in the form of a rechargeable battery. Thus, in embodiments where the hockey puck 1 includes an energy harvester 28, the hockey puck 1 will be charged merely by being used, such as during ice hockey practicing.

The electric circuit board 9 comprises an audible generator 31 at an upper portion. Interposed between the audible generator 31 and the plate of the first lid 15 that constitutes the lid surface 19, there is a gasket 33. In the shown embodiment, the gasket 33 is in the form of a rectangular O-ring. As can be appreciated from FIG. 5, the gasket 33 is configured to encircle the positions of all the through holes 23, when the hockey puck 1 is assembled for use.

Still referring to FIG. 5, the first lid 15 comprises a cylindrical wall 35 that extends perpendicularly from the lid surface 19 as a circular cylinder. There is a plurality of cut-outs 37 in the cylindrical wall 35, which define flexible wall sections 39. At the ends of the flexible wall sections 39, there is arranged a radially extending lip 41.

As shown in the enlarged cross-section side view of FIG. 6, the lips 41 are configured to engage with a circular notch 43 in the first recess 5. The circular notch 43 is arranged some distance from the first body surface 7. Also shown in FIG. 6 is an inclined surface 45 arranged on the lips 41. The inclined surfaces 45 on the lips 41 are configured to slide against the peripheral edge between the first body surface 7 and the first recess 5 when the first lid 15 is mounted to the puck body 3. When mounted, the first lid 15 is arranged to retain the electric circuit board 9 in place. Moreover, when the lid 15 is mounted, it retains the gasket 33 in position between the lid 15 and the audible generator 31. The packer 33 prevents contamination of the first recess 5, such as dust, water or other contaminants.

Sound generated by the audible generator 31 will be transmitted through the acoustic transmission arrangement 23, which in the shown embodiment is in the form of the through holes in the first lid 15.

Advantageously, the second lid 17 can be mounted to the puck body 3 in the same manner as the first lid 15. For simplicity, the corresponding components for attaching the second lid 17 are given the same reference numbers as for the first lid 15, such as the lip 41, inclined surface 45, and the circular notch 43 in the second recess 11.

The second lid 17 is configured to retain the wireless charger 27 in place in the second recess 11.

Also shown in FIG. 6 is a circuit board retainer notch 55, which is arranged in the first lid 15. The circuit board retainer notch 55 engages with the peripheral edge of the circuit board 9, thereby retaining the latter in position.

Reference is now made to FIG. 7, which is an enlarged perspective view of the circuit board 9, depicting some of its components. The circuit board 9 comprises a first accelerometer 101. The first accelerometer 101 is configured to measure acceleration of the hockey puck 1. Such acceleration can typically occur when the puck is passed between hockey players, when the puck is shot, or when hitting the rink boards or saved by a goal keeper.

In the shown embodiment, the circuit board 9 can advantageously also comprise a second accelerometer 103. The second accelerometer 103 has another measuring range than the first accelerometer 101. Thus, with two different accelerometers, a larger range of accelerations can be measured. For instance, the first accelerometer 101 can measure a lower range of accelerations than the second accelerometer 103, such as occurring when the hockey puck 1 is softly received with the stick after a good pass. The second accelerometer 103 can then measure accelerations of a higher range, such as occurring during shots.

The circuit board 9 can further comprise a gyro 105. With the gyro 5, possible rotation of the hockey puck 1 can be measured.

The circuit board 9 can comprise an antenna 107. With the antenna 107, wireless communication can be provided.

Moreover, the circuit board 9 can have a control unit 109, such as a microcontroller.

The first accelerometer 101 is connected to the control unit 109, thus providing values relating to the acceleration of the hockey puck 1.

The second accelerometer 103 and/or the gyro 105 and/or the antenna 107 can advantageously also be connected to the control unit 109.

As is also shown in FIG. 7, the circuit board 9 can comprise a light source 111. In this embodiment, the circuit board 9 comprises two light emitting diodes (LEDs) 111. In embodiments where the circuit board 9 includes a light source 111, the first lid 15 and/or the second lid 17 is made of a transparent material, such as a transparent plastic.

It will be appreciated that the light source 111, of which there may be several, may be arranged to other portions than the circuit board 9. Preferably, light sources 111 are arranged on both sides of the puck body 3, such that when actuated, the light is visible regardless of which of its two sides the hockey puck 1 is oriented.

It will now be understood that the various components that measure the acceleration or rotation of the hockey puck 1, and/or the antenna 107, are connected to the control unit 109. The control unit 109 is configured to provide output to the audible generator 31 and/or the light sources 111 based on such input. In some embodiments, the control unit 109 may be configured to provide output to the antenna 107 in order to provide information to an external component (not shown). Such an external component may for instance be a smartphone or a tablet that may communicate wirelessly with the control unit 109 via the antenna 107.

Thus in some embodiments, the control unit 109 is configured to receive input from the antenna 107 and/or send information out through the antenna 107.

In particular, in some embodiments, the external component (e.g. smartphone or tablet) may be used to make the control unit 109 facilitate particular training programs. For instance, the puck could “talk” back to the player with voice guidance and ask the player to perform various shots, receivings, etc, while storing measured parameters (such as measured by the accelerometer 101, 103 or the gyro 105). Before practice, the control unit 101 of the hockey puck 1 can be programmed thru e.g. a smart phone or tablet for specific tasks. When in a pass practice mode, the hockey puck 1 will give immediate feedback each time when the pass is received too hard. If in shooting practice mode, the puck can be programmed to give immediate feedback on speed and rotation for each shot.

Reference is made to FIG. 8, which depicts the first lid 15 with a top view. On the inner portion of the cylindrical wall 35 there is arranged a protrusion 47. The protrusion 47 is configured to engage with a groove 49 on the perimeter of the circuit board 9. The groove 49 is shown in FIG. 7. Their mutual engagement can be appreciated from FIG. 3.

It is again referred to FIG. 2, which inter alia depicts the channel 13 extending between the first and second recesses 5, 11. While not shown herein, an electric connection is established between the wireless charger 27 and the power supply 25. Such electric connection may be established with electric wire, or an electric contact that can be automatically made when installing the power supply 25 and the circuit board 9.

In some embodiments, the control unit 109 may comprise a memory unit. During use of the hockey puck 1, the various measurements can thus be stored in the memory unit and communicated to the external component (e.g. a tablet).

1. A hockey puck comprising:
an accelerometer;
a puck body;
wherein the accelerometer is arranged in a recess of the puck body;
wherein the accelerometer is configured to measure the acceleration of the hockey puck in at least one direction in x-y-z coordinates;
a power supply; and
a control unit configured to read sensor input from the accelerometer and to provide a control unit output based on said sensor input.

2. The hockey puck according to claim 1, wherein the accelerometer is placed away from the center of gravity of the hockey puck.

3. puck according to claim 1, comprising:
wherein the accelerometer is a first accelerometer;
a second accelerometer; and
wherein a measuring range of the first accelerometer and a measuring range of the second accelerometer are different.

4. The hockey puck according to claim 1, comprising a gyro configured to measure rotational speed of the hockey puck.

5. The hockey puck according to claim 1, wherein the power supply is connected to a wireless charger.

6. The hockey puck according to claim 1, comprising at least one of:
an audible generator configured to produce a sound based on the control unit output, as the audible generator is operated by the control unit; and
a light source configured to provide a light, based on the control unit output, as the light source is operated by the control unit.

7. The hockey puck according to claim 1, comprising a radio signal transceiver or transmitter antenna that enables data exchange with an external device.

8. The hockey puck according to claim 1, comprising:
a lid made of a transparent material;
wherein the lid comprises flexible wall sections with radially extending lips; and
wherein the lips are configured to engage with a notch provided in the recess.

9. The hockey puck according to claim 1, comprising:
wherein the recess is a first recess recessed in a first body surface;
wherein the puck body comprises a second recess recessed in a second, opposite body surface, and
wherein a channel extends between the first and second recesses.

10. A method of practicing ice hockey by using a hockey puck according to claim 1, the method comprising:
a) establishing a wireless communication path between the control unit and an external device, such as a smart phone, computer, or tablet;
b) with the external device, configuring a practice session mode in the control unit, including adjusting a setting of impact force, rotation speed, or other practice parameters;
c) handling the hockey puck with a hockey stick;
at least one of the following steps:
d) during step c), storing measured practice parameters in a memory unit in the hockey puck; and
e) with the control unit, actuating output parameters as immediate feedback to the player practicing ice hockey.

11. The method according to claim 10, wherein the external device is selected from the group consisting of a smart phone, a computer, and a tablet.

12. The method according to claim 10, wherein the handling is selected from the group consisting of passing and shooting.

13. The method according to claim 10, wherein with the output parameters comprise at least one of sound with the audible generator and light with the light source.
